(19) United States
(12) Patent Application Publication
(10) Pub. No.: US 2024/0359538 A1
(43) Pub. Date: Oct. 31, 2024

(54) DEVICE FOR SHADING THE SUNLIGHT OF A VEHICLE, METHOD FOR CONTROLLING THE SAME, AND COMPUTER READABLE RECORDING MEDIUM STORING PROGRAM FOR PERFORMING THE METHOD

(71) Applicant: HL MANDO CORPORATION, Gyeonggi-do (KR)

(72) Inventors: Eun Jung NO, Gyeonggi-do (KR); Bum Rae CHO, Gyeonggi-do (KR)

(21) Appl. No.: 18/646,504

(22) Filed: Apr. 25, 2024

(30) Foreign Application Priority Data
Apr. 25, 2023 (KR) 10-2023-0053859

(51) Int. Cl. B60J 3/04; G02F 1/133; G02F 1/169

(52) U.S. Cl. CPC B60J 3/04; G02F 1/13318; G02F 1/169; G02F 2203/01

(57) ABSTRACT

A vehicle sunlight shading device, a method for controlling the same, and a computer-readable storage medium storing a program for performing the method are disclosed. The vehicle sunlight shading device according to an exemplary embodiment of the present disclosure may include a sunlight shading member installed in a vehicle and having an adjustable transmittance; an illuminance sensor that measures an illuminance around the vehicle; and a controller that adjusts the transmittance of the sunlight shading member based on the illuminance measured by the illuminance sensor.

### CROSS-REFERENCE TO RELATED APPLICATION

This application claims priority to and the benefit of Korean Patent Application No. 10-2023-0053859, filed on Apr. 25, 2023, the disclosures of which is incorporated herein by reference in its entirety.

### BACKGROUND

### 1. Technical Field

The present disclosure relates to a vehicle sunlight shading device, a method for controlling the same, and a computer-readable storage medium storing a program for performing the method, and more particularly, to a vehicle sunlight shading device installed in a vehicle to block sunlight that interferes with the driver's vision, a method for controlling the same, and a computer-readable storage medium storing a program for performing the method.

### 2. Discussion of Related Art

A sun visor is installed on a vehicle to block sunlight that obstructs the driver's vision while driving. Generally, the sun visor is placed on the upper part of the front window of a vehicle in an angle-adjustable form, and the driver appropriately adjusts the angle of the sun visor according to the angle at which sunlight is irradiated.

Conventional sun visors are made of opaque materials and their transparency cannot be adjusted. Accordingly, there is a problem in that the driver's forward view is greatly disturbed depending on the placement angle of the sun visor. In addition, the driver must directly adjust the angle of the sun visor according to the irradiation angle of sunlight or ambient illuminance while driving, and the process of adjusting the placement angle of the sun visor while driving is not only cumbersome, but there is also a risk of causing an accident by dispersing the driver's attention.

Accordingly, there is a growing demand for a new technology for blocking sunlight in vehicles that can replace conventional sun visors that require adjustment of the angle by the driver and risk interfering with the driver's vision.

Accordingly, it is required to develop a technology that maximizes the advantages of each acceleration sensor and gyro sensor and compensates for the disadvantages so that the angle related to the vehicle's posture can be accurately estimated.

Meanwhile, with the development of autonomous driving technology, the level of demand for securing redundancy related to vehicle safety, the robustness of measurement, and the like is increasing. In this regard, there is also an increasing need to develop a technology that enables estimating an angle related to the vehicle's posture even if either of the acceleration sensor or gyro sensor installed in the vehicle fails.

(Patent Document) Korean Patent Registration No. 10-1091391, “Sun-visor of vehicles”, registered in Dec. 1, 2011.

### SUMMARY

The present disclosure is to solve the problems of the related art described above, and the present disclosure is directed to providing a vehicle sunlight shading device, a method for controlling the same, and a computer-readable storage medium storing a program for performing the method in which the transmittance of a sunlight shading member can be adjusted in accordance with changing illuminance while driving.

In addition, the present disclosure is also directed to providing a vehicle sunlight shading device, a method for controlling the same, and a computer-readable storage medium storing a program for performing the method in which the transmittance of the sunlight shading member can be adjusted by taking into account the illuminance, the tilt of the vehicle, the speed of the vehicle, and whether rainwater is detected, and so on.

In addition, the present disclosure is also directed to providing a vehicle sunlight shading device, a method for controlling the same, and a computer-readable storage medium storing a program for performing the method that can prevent unnecessary adjustment of transmittance of the sunlight shading member in consideration of the degree of change in illuminance.

In addition, the present disclosure is also directed to providing a vehicle sunlight shading device, a method for controlling the same, and a computer-readable storage medium storing a program for performing the method that do not need to adjust the placement angle of the sunlight shading member according to the irradiation angle of sunlight, etc.

The objects of the present disclosure are not limited to the above-described objects, and other objects that are not mentioned will be able to be clearly understood by those skilled in the art to which the present disclosure pertains from the following description.

According to an aspect of the present disclosure, provided is a vehicle sunlight shading device, including a sunlight shading member installed in a vehicle and having an adjustable transmittance; an illuminance sensor that measures an illuminance around the vehicle; and a controller that adjusts the transmittance of the sunlight shading member based on the illuminance measured by the illuminance sensor.

In addition, the vehicle sunlight shading device according to an aspect of the present disclosure may further include a tilt sensor that measures a tilt of the vehicle, and the controller may determine an amount of illuminance felt by a driver of the vehicle based on the illuminance measured by the illuminance sensor and the tilt of the vehicle measured by the tilt sensor, and adjust the transmittance of the sunlight shading member based on the amount of felt illuminance.

In addition, in the vehicle sunlight shading device according to an aspect of the present disclosure, when the measured tilt of the vehicle is an uphill slope, the controller may determine by increasing the amount of felt illuminance compared to when the measured tilt of the vehicle is on a flat surface.

In addition, in the vehicle sunlight shading device according to an aspect of the present disclosure, when the measured tilt of the vehicle is a downhill slope, the controller may determine by decreasing the amount of felt illuminance compared to when the measured tilt of the vehicle is on a flat surface.

In addition, the vehicle sunlight shading device according to an aspect of the present disclosure may further include a speed sensor that measures a speed of the vehicle, and the controller may adjust a speed of change in transmittance of the sunlight shading member based on the speed of the vehicle measured by the speed sensor.

In addition, in the vehicle sunlight shading device according to an aspect of the present disclosure, the controller may increase a speed of change in transmittance of the sunlight shading member in proportion to the measured speed of the vehicle.

In addition, the vehicle sunlight shading device according to an aspect of the present disclosure may further include a rainwater sensor that detects rainwater, and the controller may reduce a speed of change in transmittance of the sunlight shading member when rainwater is detected by the rainwater sensor.

In addition, in the vehicle sunlight shading device according to an aspect of the present disclosure, the controller may maintain a constant transmittance of the sunlight shading member when the number of times the illuminance measured by the illuminance sensor changes by a set magnitude or more within a predetermined time occurs n (n is a natural number) times or more within a predetermined period.

In addition, in the vehicle sunlight shading device according to an aspect of the present disclosure, the predetermined time may be selected in a range greater than 0 seconds and equal to or less than 10 seconds.

In addition, the vehicle sunlight shading device according to an aspect of the present disclosure may further include a mode switch that receives selection information for any one of two or more adjustment modes in which the correlation between the illuminance and the transmittance is set to be different from each other in relation to the adjustment of the transmittance of the sunlight shading member, and the controller may store the two or more adjustment modes, and adjust the transmittance of the sunlight shading member according to the correlation between the illuminance and the transmittance corresponding to the adjustment mode selected through the mode switch.

In addition, the vehicle sunlight shading device according to an aspect of the present disclosure may further include a speed switch that receives setting information on the speed of change in transmittance in relation to adjusting the transmittance of the sunlight shading member, and the controller may adjust the speed of change in transmittance of the sunlight shading member by reflecting setting information input through the speed switch.

According to another aspect of the present disclosure, provided is a method for controlling a vehicle sunlight shading device comprising a sunlight shading member installed in a vehicle and having an adjustable transmittance, the method including storing, by a controller, illuminance measured by an illuminance sensor; and adjusting, by the controller, the transmittance of the sunlight shading member based on the illuminance.

The method for controlling a vehicle sunlight shading device according to another aspect of the present disclosure may further include storing, by the controller, a tilt of the vehicle measured by a tilt sensor, and the adjusting the transmittance may include determining, by the controller, an amount of felt illuminance based on the illuminance and the tilt; and adjusting, by the controller, the transmittance of the sunlight shading member based on the amount of felt illuminance.

In addition, in the method for controlling a vehicle sunlight shading device according to another aspect of the present disclosure, in the determining the amount of felt illuminance, when the measured tilt of the vehicle is an uphill slope, the controller may determine by increasing the amount of felt illuminance compared to when the measured tilt of the vehicle is on a flat surface.

In addition, in the method for controlling a vehicle sunlight shading device according to another aspect of the present disclosure, in the determining the amount of felt illuminance, when the measured tilt of the vehicle is a downhill slope, the controller may determine by decreasing the amount of felt illuminance compared to when the measured tilt of the vehicle is on a flat surface.

The method for controlling a vehicle sunlight shading device according to another aspect of the present disclosure may further include storing, by the controller, a speed of the vehicle measured by a speed sensor, and the adjusting the transmittance may include determining, by the controller, a speed of change in transmittance of the sunlight shading member based on the speed of the vehicle; and adjusting, by the controller, the transmittance of the sunlight shading member based on the determined speed of change.

In addition, in the method for controlling a vehicle sunlight shading device according to another aspect of the present disclosure, in the determining the speed of change in transmittance, the controller may increase the speed of change in transmittance of the sunlight shading member in proportion to the speed of the vehicle.

The method for controlling a vehicle sunlight shading device according to another aspect of the present disclosure may further include storing, by the controller, rainwater detection information detected by a rainwater sensor, and the adjusting the transmittance may include determining, by the controller, the speed of change in transmittance of the sunlight shading member based on the rainwater detection information; and adjusting, by the controller, the transmittance of the sunlight shading member based on the determined speed of change.

In addition, in the method for controlling a vehicle sunlight shading device according to another aspect of the present disclosure, in the determining the speed of change in transmittance, the controller may reduce the speed of change in transmittance of the sunlight shading member when the rainwater detection information is present.

In addition, the method for controlling a vehicle sunlight shading device according to another aspect of the present disclosure may further include determining, by the controller, whether the number of times the illuminance changes by a set magnitude or more within a predetermined time has occurred n (n is a natural number) times or more within a predetermined period.

In addition, in the method for controlling a vehicle sunlight shading device according to another aspect of the present disclosure, the predetermined time may be selected in a range greater than 0 seconds and equal to or less than 10 seconds.

In addition, the method for controlling a vehicle sunlight shading device according to another aspect of the present disclosure may further include maintaining a constant transmittance of the sunlight shading member when the controller determines that the number of times the illuminance changes by a set magnitude or more within a predetermined time has occurred n (n is a natural number) times or more within a predetermined period.

In addition, the method for controlling a vehicle sunlight shading device according to another aspect of the present disclosure may further include receiving, by the controller, selection information for any one of two or more adjustment modes in which the correlation between the illuminance and the transmittance is set to be different from each other in relation to the adjustment of the transmittance of the sunlight shading member, and in the adjusting the transmittance, the controller may adjust the transmittance according to an adjustment mode corresponding to selection information received by the controller.

In addition, the method for controlling a vehicle sunlight shading device according to another aspect of the present disclosure may further include receiving, by the controller, setting information on the speed of change in transmittance in relation to adjusting the transmittance of the sunlight shading member, and in the adjusting the transmittance, the controller may adjust the transmittance by reflecting the input speed of change in transmittance.

According to yet another aspect of the present disclosure, provided is a non-transitory computer-readable storage medium having stored thereon a program including at least one instruction for performing the method for controlling a vehicle sunlight shading device.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a vehicle sunlight shading device according to an exemplary embodiment of the present disclosure.

FIG. 2 is a diagram illustrating an example of adjusting the transmittance of a sunlight shading member of a vehicle sunlight shading device according to an exemplary embodiment of the present disclosure.

FIG. 3 is a diagram illustrating an example of a speed of change in transmittance of a sunlight shading member of a vehicle sunlight shading device according to an exemplary embodiment of the present disclosure.

FIG. 4 is a diagram illustrating an example of an illuminance and a transmittance map of a sunlight shading member applicable to a vehicle sunlight shading device according to an exemplary embodiment of the present disclosure.

FIG. 5 is a flowchart of a method for controlling a vehicle sunlight shading device according to an exemplary embodiment of the present disclosure.

FIG. 6 is a flowchart of a method for controlling a vehicle sunlight shading device according to another exemplary embodiment of the present disclosure.

FIG. 7 is a detailed flowchart of the step of adjusting the transmittance of a sunlight shading member in the method for controlling the vehicle sunlight shading device according to another exemplary embodiment of the present disclosure shown in FIG. 6.

FIG. 8 is a flowchart of a method for controlling a vehicle sunlight shading device according to yet another exemplary embodiment of the present disclosure.

FIG. 9 is a detailed flowchart of the step of adjusting the transmittance of a sunlight shading member in the method for controlling the vehicle sunlight shading device according to yet another exemplary embodiment of the present disclosure shown in FIG. 8.

FIG. 10 is a flowchart of a method for controlling a vehicle sunlight shading device according to yet another exemplary embodiment of the present disclosure.

FIG. 11 is a detailed flowchart of the step of adjusting the transmittance of a sunlight shading member in the method for controlling the vehicle sunlight shading device according to yet another exemplary embodiment of the present disclosure shown in FIG. 10.

FIG. 12 is a flowchart of a method for controlling a vehicle sunlight shading device according to yet another exemplary embodiment of the present disclosure.

FIG. 13 is a flowchart of a method for controlling a vehicle sunlight shading device according to yet another exemplary embodiment of the present disclosure.

FIG. 14 is a flowchart of a method for controlling a vehicle sunlight shading device according to yet another exemplary embodiment of the present disclosure.

FIG. 15 is a flowchart of a method for controlling a vehicle sunlight shading device according to yet another exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

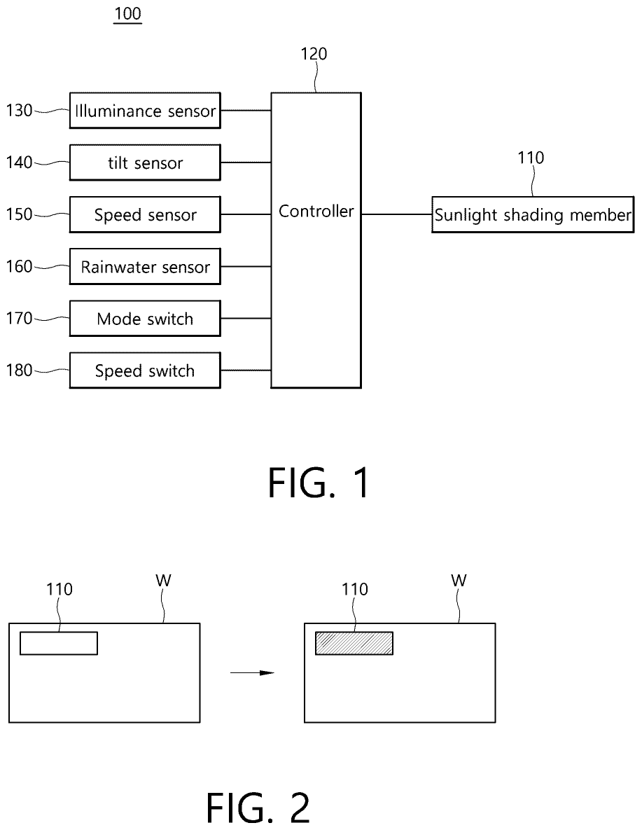

FIG. 1 is a block diagram of a vehicle sunlight shading device according to an exemplary embodiment of the present disclosure.

The vehicle sunlight shading device 100 according to an exemplary embodiment of the present disclosure provides an optimal sunlight shading function to a driver by allowing the transmittance of a sunlight shading member 110 installed in a vehicle and having an adjustable transmittance to be adjusted according to the ambient illuminance. According to the vehicle sunlight shading device 100 according to an exemplary embodiment of the present disclosure, the driver does not need to adjust the placement angle of the sunlight shading member while driving. Accordingly, convenience of the driver may be improved and safety may be secured.

Referring to FIG. 1, the vehicle sunlight shading device 100 according to an exemplary embodiment of the present disclosure may include a sunlight shading member 110 and a controller 120.

The sunlight shading member 110 may be installed on a vehicle and its transmittance may be adjusted. For example, the sunlight shading member 110 may be installed on the upper portion of the front window of a vehicle. The sunlight shading member 110 may include a liquid crystal display (LCD), a suspended particle device (SPD), an EC, and the like. More specifically, the sunlight shading member 110 may include any one or more of an LCD film, an SPD film, and an EC film.

When the sunlight shading member 110 includes an LCD film, it may operate in an applied voltage range of 0 to 5 VDC. In this case, as the applied voltage approaches 0V, the transmittance of the sunlight shading member 110 may increase and become transparent, and as the applied voltage approaches 5V, the transmittance may decrease and thus may become opaque. For example, the transmittance may be adjusted in the range of 10 to 70%.

When the sunlight shading member 110 includes a SPD film, the range of the working voltage may be 0 to 220 VAC. The SPD film has an opaque state when the power is turned off (the applied voltage is 0V). Meanwhile, when the sunlight shading member 110 includes an EC film, the range of the working voltage may be −1.4 to 1 VAC. The EC film becomes a transparent state when the power is turned off (the applied voltage is 0V).

The above description regarding the material and working voltage of the sunlight shading member 110 is merely an example. If the transmittance can be adjusted, the sunlight shading member 110 may be made of another material. In addition, each material may have a different working voltage.

The controller 120 adjusts the transmittance of the sunlight shading member 110. For example, the controller 120 may adjust the transmittance of the sunlight shading member 110 by adjusting the voltage applied to the sunlight shading member 110. If it is not necessary to shade sunlight, the controller 120 may increase the transmittance of the sunlight shading member 110 by lowering or increasing the voltage supplied to the sunlight shading member 110. Conversely, if it is necessary to shade sunlight, such as when sunlight interferes with the driver's view, the controller 120 may lower the transmittance of the sunlight shading member 110 by increasing or lowering the voltage supplied to the sunlight shading member 110.

FIG. 2 is a diagram illustrating an example of adjusting the transmittance of a sunlight shading member of a vehicle sunlight shading device according to an exemplary embodiment of the present disclosure.

Referring to FIG. 2, a sunlight shading member 110 is disposed to shade the upper portion of the front window W of the vehicle. In this case, when the transmittance of the sunlight shading member 110 is in a high state and sunlight interferes with the driver's view and it is necessary to shade sunlight, the controller 120 changes the voltage supplied to the sunlight shading member 110, and accordingly, the transmittance of the sunlight shading member 110 decreases, thereby making it in an opaque state. As a result, sunlight irradiated to the driver may be blocked.

In an embodiment of the present disclosure, the controller 120 may basically adjust the transmittance of the sunlight shading member 110 based on the illuminance. In addition, in an embodiment of the present disclosure, the controller 120 may consider any one or more of the tilt of the vehicle, the speed of the vehicle, and whether rainwater is detected, together with the illuminance when adjusting the transmittance of the sunlight shading member 110.

In this regard, the vehicle sunlight shading device 100 according to an exemplary embodiment of the present disclosure may further include an illuminance sensor 130, a tilt sensor 140, a speed sensor 150, and a rainwater sensor 160.

The illuminance sensor 130 measures the illuminance around the vehicle. The illuminance sensor 130 may be installed in a vehicle. The illuminance measured by the illuminance sensor 130 may be the most basic variable for the controller 120 to adjust the transmittance of the sunlight shading member 110. In other words, the controller 120 may adjust the transmittance of the sunlight shading member 110 based on the illuminance measured by the illuminance sensor 130.

More specifically, when the illuminance measured by the illuminance sensor 130 is low, the controller 120 may increase the transmittance of the sunlight shading member 110 to ensure the driver's view. Conversely, when the illuminance measured by the illuminance sensor 130 is high, the controller 120 may prevent the driver's view from being disturbed by sunlight by lowering the transmittance of the sunlight shading member 110.

In relation to this, the controller 120 may store setting information regarding the transmittance of the sunlight shading member 110 for each illuminance in advance. In more detail, the controller 120 may store a transmittance map by illuminance in relation to adjusting the transmittance according to the illuminance. In this case, two or more transmittance maps by illuminance may be provided in various ways. In addition, the controller 120 may be provided with setting information about the sunlight shading member 110 for each illuminance set by the driver.

The tilt sensor 140 measures the tilt of the vehicle. The tilt sensor 140 may be installed in a vehicle. In more detail, the tilt sensor 140 is mounted in the vehicle and measures the tilt of the vehicle. It may be determined whether the vehicle is traveling on a flat surface, an uphill slope, or a downhill slope through measurement information from the tilt sensor 140.

In an embodiment of the present disclosure, the controller 120 may determine the amount of illuminance felt by the driver of the vehicle based on the illuminance measured by the illuminance sensor 130 and the tilt of the vehicle measured by the tilt sensor 140. In addition, the controller 120 may adjust the transmittance of the sunlight shading member 110 based on the amount of felt illuminance.

When the tilt of the vehicle measured by the tilt sensor 140 is an uphill slope, the controller 120 may determine by increasing the amount of felt illuminance compared to when the measured tilt of the vehicle is on a flat surface. In general, when the vehicle travels in an uphill slope, a relatively large amount of illuminance is generated compared to when traveling on a flat surface. Considering this, when the vehicle's tilt measured by the tilt sensor 140 is an uphill slope, the controller 120 may determine the amount of illuminance weighted compared to a flat surface as the amount of felt illuminance.

When the tilt of the vehicle measured by the tilt sensor 140 is a downhill slope, the controller 120 may determine by decreasing the amount of felt illuminance compared to when the measured tilt of the vehicle is on a flat surface. In general, when the vehicle travels in a downhill slope, a relatively small amount of illuminance is generated compared to when traveling on a flat surface. Considering this, when the vehicle's tilt measured by the tilt sensor 140 is a downhill slope, the controller 120 may determine the amount of illuminance reduced compared to a flat surface as the amount of felt illuminance.

The speed sensor 1500 measures the speed of the vehicle. In more detail, the speed sensor 150 may be mounted in the vehicle and measure the speed of the vehicle. The controller 120 may adjust the speed of change in transmittance of the sunlight shading member 110 based on the speed of the vehicle measured by the speed sensor 150.

In an embodiment of the present disclosure, the controller 120 may increase the speed of change in transmittance of the sunlight shading member 110 in proportion to the speed of the vehicle measured by the speed sensor 150. In other words, the controller 120 may increase the speed of transmittance of the sunlight shading member 110 as the speed of the vehicle measured by the speed sensor 150 is faster, and may decrease the speed of transmission of the sunlight shading member 110 as the speed of the vehicle measured by the speed sensor 150 is slower.

If the speed of change in transmittance of the sunlight shading member 110 is too fast or too slow during driving of the vehicle, the driver may feel uncomfortable. For example, if the transmittance of the sunlight shading member 110 is slowly increased when entering a tunnel while the sunlight shading member 110 is opaque, the driver's view may be disturbed. Conversely, when the sunlight shading member 110 advances from the tunnel to the outside in a transparent state, the driver may feel glare if the transmittance of the sunlight shading member 110 is slowly lowered. At this time, the speed of change in transmittance felt by the driver may have a positive correlation with the speed of the vehicle.

Based on this fact, the controller 120 may increase the speed of change in transmittance of the sunlight shading member 110 as the speed of the vehicle measured by the speed sensor 150 increases. In addition, the controller 120 may reduce the speed of change in transmittance of the sunlight shading member 110 as the speed of the vehicle measured by the speed sensor 150 decreases.

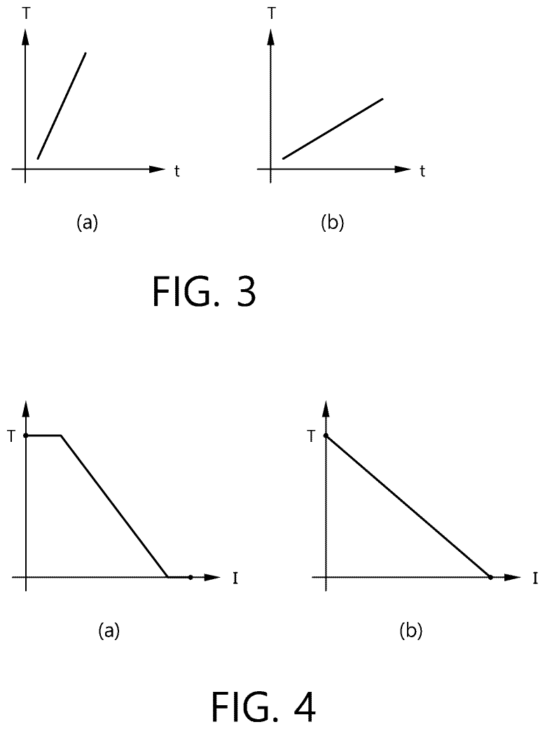

FIG. 3 is a diagram illustrating an example of a speed of change in transmittance of a sunlight shading member of a vehicle sunlight shading device according to an exemplary embodiment of the present disclosure.

FIG. 3 (a) shows a state in which the speed of change in transmittance (T) of the sunlight shading member 110 according to the flow of time (t) is set relatively large when the transmittance is increased, and FIG. 3 (b) shows a state in which the speed of change in transmittance (T) of the sunlight shading member 110 according to the flow of time (t) is set relatively small when the transmittance is increased. Of course, in addition to these two states, the speed of change in transmittance of the sunlight shading member 110 may be set to various sizes. In addition, the speed of change in transmittance of the sunlight shading member 110 may be selected from non-continuous (discrete) values or may be selected from a continuous range.

The rainwater sensor 160 detects rainwater. The rainwater sensor 160 may be installed in a vehicle. In more detail, the rainwater sensor 160 may be mounted in a vehicle and detect rainwater falling on the front window (W) of the vehicle. In this case, the controller 120 may change the speed of change in transmittance of the sunlight shading member 110 when rainwater is detected by the rainwater sensor 160.

In an embodiment of the present disclosure, the controller 120 may reduce the speed of change in transmittance of the sunlight shading member 110 when rainwater is detected by the rainwater sensor 160. When rainwater is detected by the rainwater sensor 160, it can be generally assumed that the day is cloudy. In addition, when the day is cloudy, there is less glare from sunlight compared to a clear day. Based on this fact, the controller 120 may provide appropriate shade to the driver by reducing the speed of change in transmittance of the sunlight shading member 110 when rainwater is detected by the rainwater sensor 160.

In an embodiment of the present disclosure, in addition to the illuminance measured by the illuminance sensor 130, the controller 120 may consider the driver's preference regarding the illuminance and transmittance of the sunlight shading member 110 when adjusting the transmittance of the sunlight shading member 110. In this regard, the vehicle sunlight shading device 100 according to an exemplary embodiment of the present disclosure may further include a mode switch 170.

The mode switch 170 receives selection information for any one of two or more adjustment modes in which the correlation between the illuminance and the transmittance is set to be different from each other. In more detail, the mode switch 170 provides an interface through which a driver may input selection information for the adjustment mode. For example, the mode switch 170 may provide an interface such as a touch screen, a knob, and a button.

Here, each adjustment mode has a transmittance map by illuminance of the sunlight shading member corresponding thereto. In other words, the adjustment mode is a concept corresponding to the transmittance map of the sunlight shading member for each illuminance, and each adjustment mode may have a unique transmittance map of the sunlight shading member for each illuminance.

FIG. 4 is a diagram illustrating an example of an illuminance and a transmittance map of a sunlight shading member applicable to a vehicle sunlight shading device according to an exemplary embodiment of the present disclosure.

FIG. 4 (a) shows a first adjustment mode in which the transmittance (T) is maintained to the maximum until a predetermined illuminance and the transmittance decreases relatively rapidly as the illuminance (I) increases. In addition, FIG. 4 (b) shows a second adjustment mode in which the transmittance (T) decreases relatively smoothly as the illuminance (I) increases. For example, the first mode may be referred to as a hard mode, and the second mode may be referred to as a soft mode.

Of course, the map shown in FIG. 4 is exemplary, and the maximum transmittance, the minimum transmittance, and the transmittance by illuminance, and the like may be variously set. That is, two or more transmittance maps of the illuminance and the sunlight shading member may be provided. In addition, it may be considered that a user-set map in which the maximum transmittance, minimum transmittance, and transmittance by illuminance are arbitrarily set by the driver is generated.

The controller 120 stores the two or more adjustment modes. In addition, the controller 120 may adjust the transmittance of the sunlight shading member 110 according to the correlation between the illuminance and the transmittance corresponding to the adjustment mode selected through the mode switch 170.

In an embodiment of the present disclosure, in addition to the illuminance measured by the illuminance sensor 130, the controller 120 may consider the driver's preference regarding the speed of change in transmittance of the sunlight shading member 110 when adjusting the transmittance of the sunlight shading member 110. In this regard, the vehicle sunlight shading device 100 according to an exemplary embodiment of the present disclosure may further include a speed switch 180.

The speed switch 180 receives setting information on the speed of change in transmittance in relation to adjusting the transmittance of the sunlight shading member 110. In more detail, the speed switch 180 provides an interface through which a driver may input selection information on the speed of change in transmittance. For example, the speed switch 170 may provide an interface such as a touch screen, a knob, and a button.

The controller 120 may adjust the speed of change in transmittance of the sunlight shading member 110 by reflecting the setting information input through the speed switch 180. The speed of change in transmittance is a concept distinguished from the transmittance by illuminance of the sunlight shading member 110. The speed of change in transmittance refers to a speed (time) required to change from the existing transmittance to the changed transmittance corresponding to the changed illuminance when the illuminance is changed on the transmittance map of the illuminance and the sunlight shading member. That is, even when a specific adjustment mode is selected, the speed at which the transmittance corresponding to the changed illuminance is reached when the ambient illuminance is changed may be set in various ways.

The controller 120 may preferentially utilize the setting information input through the speed switch 180, prior to the speed of change in transmittance set based on the speed of the vehicle measured by the speed sensor 150, the rainwater information detected by the rainwater sensor 160, and the like. For example, regardless of the speed of change in transmittance set based on the speed of the vehicle measured by the speed sensor 150, the rainwater information detected by the rainwater sensor 160, and the like, the controller 120 may set a speed of change in transmittance of the sunlight shading member 110 according to setting information input through the speed switch 180.

Meanwhile, in an embodiment of the present disclosure, the controller 120 may maintain a constant transmittance of the sunlight shading member 110 when the number of times the illuminance measured by the illuminance sensor 130 changes by a set magnitude or more within a predetermined time occurs n (n is a natural number) times or more within a predetermined period. For example, the predetermined time may be selected in a range greater than 0 seconds and equal to or less than 10 seconds. In addition, the reference value, number of changes, and predetermined period of the magnitude of change in illuminance may be set differently depending on the vehicle and environment.

When sunlight is non-continuously radiated onto a vehicle at predetermined time intervals due to objects around the road such as street trees, topography, etc., the driver may feel rather heterogeneous or uncomfortable if the transmittance of the sunlight shading member 110 changes each time the sunlight is irradiated. In consideration of this point in the vehicle sunlight shading device 100 according to an exemplary embodiment of the present disclosure, the controller 120 may ensure that the transmittance of the sunlight shading member 110 is kept constant when the number of times the illuminance measured by the illuminance sensor 130 changes by a set magnitude or more within a predetermined time occurs n (n is a natural number) times or more within a predetermined period.

As described above, the vehicle sunlight shading device 100 according to an exemplary embodiment of the present disclosure has been described in detail. Hereinafter, a method for controlling a vehicle sunlight shading device according to an exemplary embodiment of the present disclosure will be described.

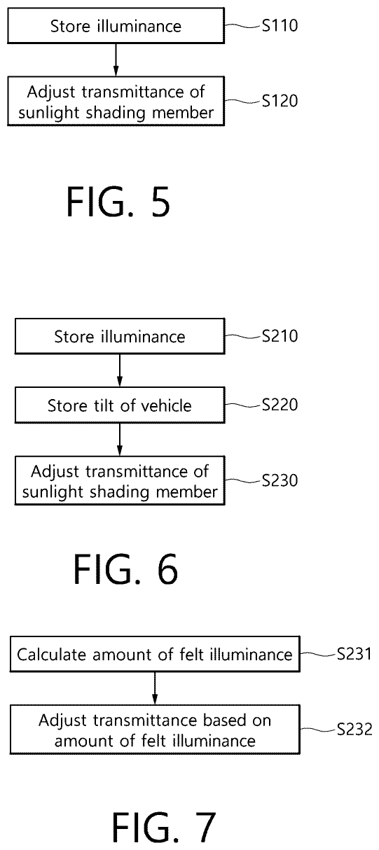

FIG. 5 is a flowchart of a method for controlling a vehicle sunlight shading device according to an exemplary embodiment of the present disclosure.

The method for controlling a vehicle sunlight shading device according to an exemplary embodiment of the present disclosure may be used to control the vehicle sunlight shading device 100 according to an exemplary embodiment of the present disclosure. That is, the method for controlling a vehicle sunlight shading device according to an exemplary embodiment of the present disclosure may be used to control the vehicle sunlight shading device 100 that includes the sunlight shading member 110, the controller 120, and the illuminance sensor 130.

Hereinafter, with reference to FIG. 5, the method for controlling a vehicle sunlight shading device according to an exemplary embodiment of the present disclosure will be described in detail.

First, the controller 120 stores illuminance measured by the illuminance sensor 130 (S110). As described above, the illuminance measured by the illuminance sensor 130 may be the most basic variable for the controller 120 to adjust the transmittance of the sunlight shading member 110.

Next, the controller 120 adjusts the transmittance of the sunlight shading member 110 based on the illuminance (S120). For example, when the illuminance measured by the illuminance sensor 130 is low, the controller 120 may increase the transmittance of the sunlight shading member 110 to ensure the driver's view. Conversely, when the illuminance measured by the illuminance sensor 130 is high, the controller 120 may prevent the driver's view from being disturbed by sunlight by lowering the transmittance of the sunlight shading member 110.

In relation to this, the controller 120 may store setting information regarding the transmittance of the sunlight shading member 110 for each illuminance in advance. In addition, the controller 120 may be provided with setting information about the sunlight shading member 110 for each illuminance set by the driver. Specifically, as described above, the controller 120 may store a transmittance map by illuminance in relation to adjusting the transmittance according to the illuminance. In this case, two or more transmittance maps by illuminance may be provided in various ways.

FIG. 6 is a flowchart of a method for controlling a vehicle sunlight shading device according to another exemplary embodiment of the present disclosure. In addition, FIG. 7 is a detailed flowchart of the step of adjusting the transmittance of a sunlight shading member in the method for controlling the vehicle sunlight shading device according to another exemplary embodiment of the present disclosure shown in FIG. 6.

The method for controlling a vehicle sunlight shading device according to an exemplary embodiment of the present disclosure will be described with reference to FIGS. 6 and 7.

First, the controller 120 stores illuminance measured by the illuminance sensor 130 (S210). The illuminance measured by the illuminance sensor 130 is the most basic variable for the controller 120 to adjust the transmittance of the sunlight shading member 110.

Next, the controller 120 stores a tilt of the vehicle measured by the tilt sensor 140 (S220). It may be determined whether the vehicle is traveling on a flat surface, an uphill slope, or a downhill slope through measurement information from the tilt sensor 140.

Finally, the controller 120 adjusts the transmittance of the sunlight shading member 110 (S230). The controller 120 may adjust the transmittance of the sunlight shading member 110 by considering both the illuminance measured by the illuminance sensor 130 and the tilt of the vehicle measured by the tilt sensor 140.

Referring to FIG. 7, the adjustment of the transmittance may be performed as follows.

First, the controller 120 determines an amount of felt illuminance based on the illuminance and the tilt (S231). More specifically, when the measured tilt of the vehicle is an uphill slope, the controller 120 may determine by increasing the amount of felt illuminance compared to when the measured tilt of the vehicle is on a flat surface. In addition, when the measured tilt of the vehicle is a downhill slope, the controller 120 may determine by decreasing the amount of felt illuminance compared to when the measured tilt of the vehicle is on a flat surface.

Next, the controller 120 adjusts the transmittance of the sunlight shading member 110 based on the amount of felt illuminance (S232). That is, the controller 120 may adjust the transmittance by matching the amount of felt illuminance to the illuminance on the transmittance map by illuminance of the sunlight shading member 110. Specifically, the controller 120 may lower the transmittance of the sunlight shading member 110 as the amount of felt illuminance increases, thereby preventing glare of the driver. In addition, the controller 120 may ensure the driver's view by increasing the transmittance of the sunlight shading member 110 as the amount of felt illuminance decreases.

Meanwhile, in the method for controlling a vehicle sunlight shading device shown in FIG. 6, the storing, by the controller 120, the illuminance measured by the illuminance sensor 130 and the storing, by the controller 120, the tilt of the vehicle measured by the tilt sensor 140 may be performed at the same time. In addition, the storing, by the controller 120, the tilt of the vehicle measured by the tilt sensor 140 may be performed earlier, and the storing, by the controller 120, the illuminance measured by the illuminance sensor 130 may be performed later.

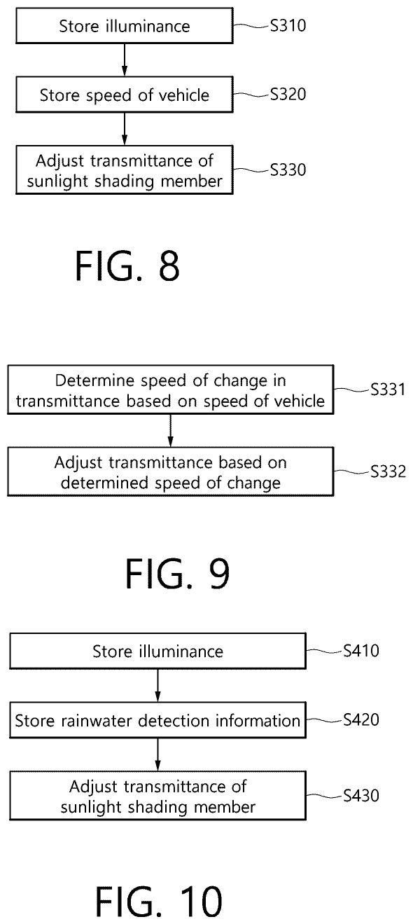

FIG. 8 is a flowchart of a method for controlling a vehicle sunlight shading device according to yet another exemplary embodiment of the present disclosure. In addition, FIG. 9 is a detailed flowchart of the step of adjusting the transmittance of a sunlight shading member in the method for controlling the vehicle sunlight shading device according to yet another exemplary embodiment of the present disclosure shown in FIG. 8.

The method for controlling a vehicle sunlight shading device according to another exemplary embodiment of the present disclosure will be described with reference to FIGS. 8 and 9.

First, the controller 120 stores illuminance measured by the illuminance sensor 130 (S310). The illuminance measured by the illuminance sensor 130 is a basic variable for the controller 120 to adjust the transmittance of the sunlight shading member 110.

Next, the controller 120 stores the speed of the vehicle measured by the speed sensor 150 (S320). The speed of the vehicle measured by the speed sensor 150 serves as a reference for determining the speed of change in transmittance of the sunlight shading member 110 according to the illuminance.

Finally, the controller 120 adjusts the transmittance of the sunlight shading member 110 (S330). The controller 120 may adjust the transmittance of the sunlight shading member 110 by considering both the illuminance measured by the illuminance sensor 130 and the speed of the vehicle measured by the speed sensor 150.

Referring to FIG. 9, the adjustment of the transmittance may be performed as follows.

First, the controller 120 determines the speed of change in transmittance of the sunlight shading member 110 based on the speed of the vehicle (S331). In more detail, the controller 120 may increase the speed of change in transmittance of the sunlight shading member 110 in proportion to the speed of the vehicle. As described above, the speed of change in transmittance felt by the driver may have a positive correlation with the speed of the vehicle. Based on this fact, the controller 120 may increase the speed of change in transmittance of the sunlight shading member 110 as the speed of the vehicle measured by the speed sensor 150 is faster, and may decrease the speed of change in transmission of the sunlight shading member 110 as the speed of the vehicle measured by the speed sensor 150 is slower.

Next, the controller 120 adjusts the transmittance of the sunlight shading member 110 based on the determined speed of change (S332). Specifically, the controller 120 may change the transmittance of the sunlight shading member 110 relatively rapidly as the determined speed of change in transmittance increases.

Meanwhile, in the method for controlling a vehicle sunlight shading device shown in FIG. 8, the storing, by the controller 120, the illuminance measured by the illuminance sensor 130 and the storing, by the controller 120, the speed of the vehicle measured by the speed sensor 150 may be performed at the same time. In addition, the storing, by the controller 120, the speed of the vehicle measured by the speed sensor 150 may be performed earlier, and the storing, by the controller 120, the illuminance measured by the illuminance sensor 130 may be performed later.

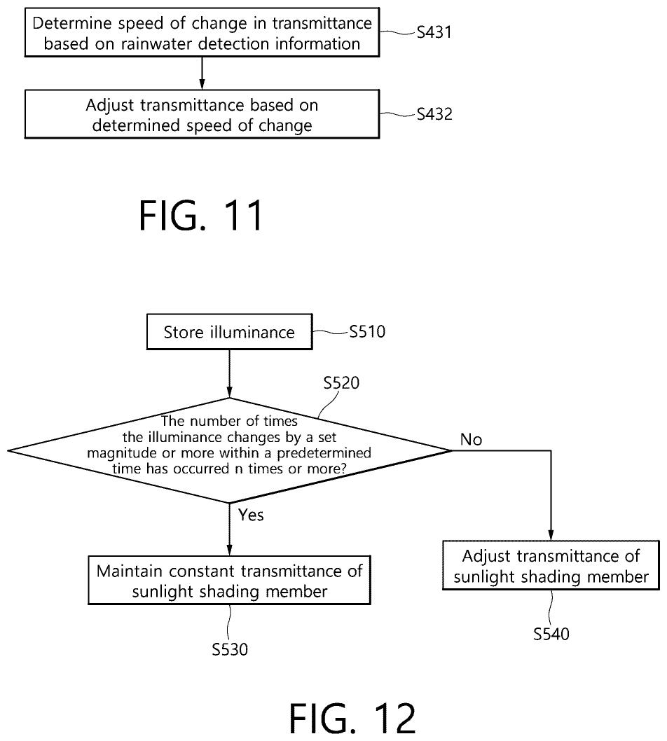

FIG. 10 is a flowchart of a method for controlling a vehicle sunlight shading device according to yet another exemplary embodiment of the present disclosure. In addition, FIG. 11 is a detailed flowchart of the step of adjusting the transmittance of a sunlight shading member in the method for controlling the vehicle sunlight shading device according to yet another exemplary embodiment of the present disclosure shown in FIG. 10.

The method for controlling a vehicle sunlight shading device according to another exemplary embodiment of the present disclosure will be described with reference to FIGS. 10 and 11.

First, the controller 120 stores illuminance measured by the illuminance sensor 130 (S410). The illuminance measured by the illuminance sensor 130 is a basic variable for the controller 120 to adjust the transmittance of the sunlight shading member 110.

Next, the controller 120 stores rainwater detection information detected by the rainwater sensor 160 (S420). The rainwater information detected by the rainwater sensor 150 may be used as a reference when determining the speed of change in transmittance of the sunlight shading member 110 according to illuminance.

Finally, the controller 120 adjusts the transmittance of the sunlight shading member 110 (S430). The controller 120 may adjust the transmittance of the sunlight shading member 110 by considering both the illuminance measured by the illuminance sensor 130 and the rainwater detection information detected by the rainwater sensor 160.

Referring to FIG. 11, the adjustment of the transmittance may be performed as follows.

First, the controller 120 determines the speed of change in transmittance of the sunlight shading member 110 based on the rainwater detection information (S431). In more detail, the controller 120 may reduce the speed of change in transmittance of the sunlight shading member 110 when rainwater is detected by the rainwater sensor 160, that is, when the rainwater detection information is present.

Next, the controller 120 adjusts the transmittance of the sunlight shading member 110 based on the determined speed of change (S432). Specifically, the controller 120 may reduce the speed of change in transmittance of the sunlight shading member 110 when the rainwater detection information is present compared to when the rainwater detection information is not present.

Meanwhile, in the method for controlling a vehicle sunlight shading device shown in FIG. 10, the storing, by the controller 120, the illuminance measured by the illuminance sensor 130 and the storing, by the controller 120, the rainwater detection information detected by the rainwater sensor 160 may be performed at the same time. In addition, the storing, by the controller 120, the rainwater detection information detected by the rainwater sensor 160 may be performed earlier, and the storing, by the controller 120, the illuminance measured by the illuminance sensor 130 may be performed later.

FIG. 12 is a flowchart of a method for controlling a vehicle sunlight shading device according to yet another exemplary embodiment of the present disclosure. The method for controlling a vehicle sunlight shading device according to another exemplary embodiment of the present disclosure will be described with reference to FIG. 12.

First, the controller 120 stores illuminance measured by the illuminance sensor 130 (S510). The illuminance measured by the illuminance sensor 130 is a basic variable for the controller 120 to adjust the transmittance of the sunlight shading member 110.

Next, the controller 120 determines whether the number of times the illuminance changes by a set magnitude or more within a predetermined time has occurred n (n is a natural number) times or more within a predetermined period (S520). For example, the predetermined time may be selected in a range greater than 0 seconds and equal to or less than 10 seconds. In addition, the reference value, number of changes, and predetermined period of the magnitude of change in illuminance may be set differently depending on the vehicle and environment.

Next, when the controller 120 determines that the number of times the illuminance changes by a set magnitude or more within a predetermined time has occurred n (n is a natural number) times or more within a predetermined period, it maintains a constant transmittance of the sunlight shading member 110 (S530). When sunlight is non-continuously radiated onto a vehicle at predetermined time intervals due to objects around the road, topography, etc., the driver may feel rather heterogeneous or uncomfortable if the transmittance of the sunlight shading member 110 changes each time the sunlight is irradiated. In consideration of this point, the controller 120 may maintain a constant transmittance of the sunlight shading member 110 when the number of times the illuminance measured by the illuminance sensor 130 changes by a set magnitude or more within a predetermined time occurs n (n is a natural number) times or more within a predetermined period.

Meanwhile, when the controller 120 determines that the number of times the illuminance changes by a set magnitude or more within a predetermined time has not occurred n (n is a natural number) times or more within a predetermined period, it adjusts the transmittance of the sunlight shading member 110 (S540). As described above, the controller 120 may basically adjust the transmittance of the sunlight shading member 110 in correspondence with a change in illuminance. In addition, in addition to the illuminance, the vehicle's tilt may be used to determine the felt illuminance. In addition, the speed of the vehicle, whether rainwater is detected, etc. may be used to determine the speed of change in transmittance.

Meanwhile, in the method for controlling a vehicle sunlight shading device shown in FIG. 12, the storing, by the controller 120, the illuminance measured by the illuminance sensor 130 and the determining, by the controller 120, whether the number of times the illuminance changes by a set magnitude or more within a predetermined time has occurred n (n is a natural number) times or more within a predetermined period may be performed at the same time. In addition, the determining, by the controller 120, whether the number of times the illuminance changes by a set magnitude or more within a predetermined time has occurred n (n is a natural number) times or more within a predetermined period may be performed earlier, and the storing, by the controller 120, the illuminance measured by the illuminance sensor 130 may be performed later.

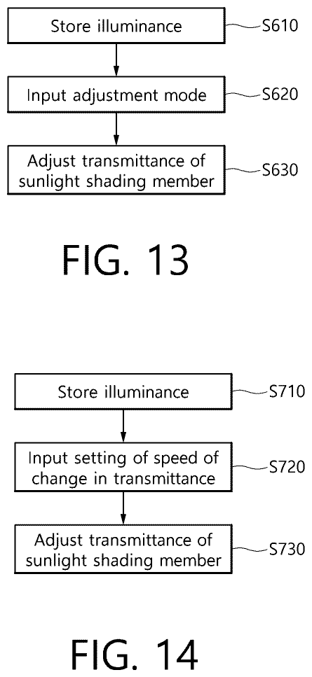

FIG. 13 is a flowchart of a method for controlling a vehicle sunlight shading device according to yet another exemplary embodiment of the present disclosure. The method for controlling a vehicle sunlight shading device according to another exemplary embodiment of the present disclosure will be described with reference to FIG. 13.

First, the controller 120 stores illuminance measured by the illuminance sensor 130 (S610). The illuminance measured by the illuminance sensor 130 is a basic variable for the controller 120 to adjust the transmittance of the sunlight shading member 110.

Next, the controller 120 receives selection information for any one of two or more adjustment modes in which the correlation between the illuminance and the transmittance is set to be different from each other in relation to the adjustment of the transmittance of the sunlight shading member 110 (S620). The two or more adjustment modes are as described with reference to FIG. 4. In other words, the adjustment mode is a concept corresponding to the transmittance map by illuminance.

In addition, in relation to the adjustment mode, the maximum transmittance, the minimum transmittance, and the transmittance by illuminance, and the like may be variously set. That is, two or more transmittance maps of the illuminance and the sunlight shading member may be provided. In addition, the maximum transmittance, minimum transmittance, and transmittance by illuminance may be arbitrarily set by the driver and input to the controller 120.

Next, the controller 120 adjusts the transmittance of the sunlight shading member 110 according to the illuminance (S630). In this case, the controller 120 may adjust the transmittance of the sunlight shading member 110 based on the transmittance map by illuminance corresponding to the input adjustment mode.

Meanwhile, in the method for controlling a vehicle sunlight shading device shown in FIG. 13, the storing, by the controller 120, the illuminance measured by the illuminance sensor 130 and the receiving, by the controller 120, selection information for any one of two or more adjustment modes may be performed at the same time. In addition, the receiving, by the controller 120, selection information for any one of two or more adjustment modes may be performed earlier, and the storing, by the controller 120, the illuminance measured by the illuminance sensor 130 may be performed later.

FIG. 14 is a flowchart of a method for controlling a vehicle sunlight shading device according to yet another exemplary embodiment of the present disclosure. The method for controlling a vehicle sunlight shading device according to another exemplary embodiment of the present disclosure will be described with reference to FIG. 14.

First, the controller 120 stores illuminance measured by the illuminance sensor 130 (S710). The illuminance measured by the illuminance sensor 130 is a basic variable for the controller 120 to adjust the transmittance of the sunlight shading member 110.

Next, the controller 120 receives setting information on the speed of change in transmittance of the sunlight shading member 110 in relation to adjusting the transmittance of the sunlight shading member 110 (S720). The speed of change in transmittance is a concept distinguished from the transmittance by illuminance of the sunlight shading member 110. The speed of change in transmittance refers to a speed (time) required to change from the existing transmittance to the changed transmittance corresponding to the changed illuminance when the illuminance is changed on the transmittance map of the illuminance and the sunlight shading member. In other words, even when a specific adjustment mode is selected, the speed at which the transmittance corresponding to the changed illuminance is reached when the ambient illuminance is changed may be set in various ways.

Next, the controller 120 adjusts the transmittance of the sunlight shading member 110 according to the illuminance (S730). The controller 120 may adjust the transmittance of the sunlight shading member 110 based on the setting information input in relation to the speed of change in transmittance.

The controller 120 may preferentially utilize the setting information input in relation to the speed of change in transmittance even when there is the speed of change in transmittance set based on the speed of the vehicle measured by the speed sensor 150, the rainwater information detected by the rainwater sensor 160, and the like. For example, regardless of the speed of change in transmittance set based on the speed of the vehicle measured by the speed sensor 150, the rainwater information detected by the rainwater sensor 160, and the like, the controller 120 may set a speed of change in transmittance of the sunlight shading member 110 according to setting information input through the speed switch 180.

Meanwhile, in the method for controlling a vehicle sunlight shading device shown in FIG. 14, the storing, by the controller 120, the illuminance measured by the illuminance sensor 130 and the receiving, by the controller 120, setting information on the speed of change in transmittance of the sunlight shading member 110 in relation to adjusting the transmittance of the sunlight shading member 110 may be performed at the same time. In addition, the receiving, by the controller 120, setting information on the speed of change in transmittance of the sunlight shading member 110 in relation to adjusting the transmittance of the sunlight shading member 110 may be performed earlier, and the storing, by the controller 120, the illuminance measured by the illuminance sensor 130 may be performed later.

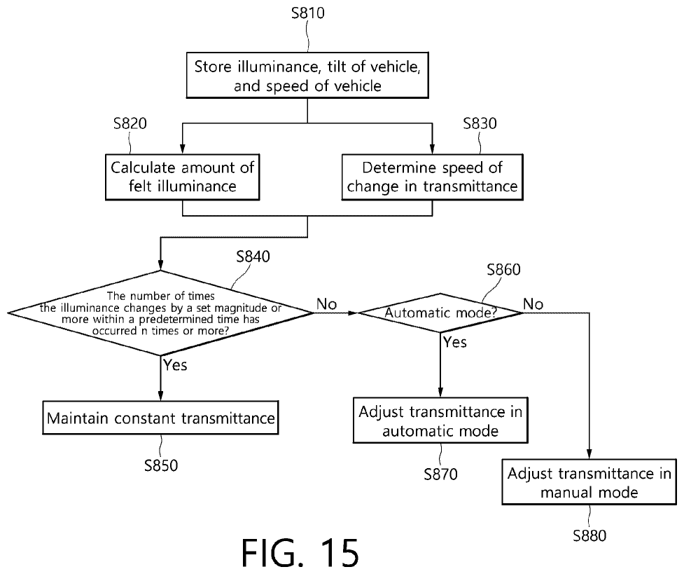

FIG. 15 is a flowchart of a method for controlling a vehicle sunlight shading device according to yet another exemplary embodiment of the present disclosure. The method for controlling a vehicle sunlight shading device according to another exemplary embodiment of the present disclosure will be described with reference to FIG. 15.

First, the controller 120 stores information measured by various sensors (S810). More specifically, the controller 120 may store the illuminance measured by the illuminance sensor 130, the tilt of the vehicle measured by the tilt sensor 140, and the speed of the vehicle measured by the speed sensor 150. The illuminance measured by the illuminance sensor 130 is a basic variable for the controller 120 to adjust the transmittance of the sunlight shading member 110. In addition, the tilt of the vehicle measured by the tilt sensor 140 may be used as a basis for determining the amount of felt illuminance of the driver of the vehicle. In addition, the speed of the vehicle measured by the speed sensor 150 may be used as a basis for determining the speed of change in transmittance.

Next, the controller 120 determines the amount of felt illuminance (S820). The controller 120 may determine the amount of felt illuminance based on the tilt of the vehicle measured by the tilt sensor 140. For example, when the measured tilt of the vehicle is an uphill slope, the controller 120 may determine by increasing the amount of felt illuminance compared to when the measured tilt of the vehicle is on a flat surface. In addition, when the measured tilt of the vehicle is a downhill slope, the controller 120 may determine by decreasing the amount of felt illuminance compared to when the measured tilt of the vehicle is on a flat surface.

Next, the controller 120 determines the speed of change in transmittance of the sunlight shading member 110 (S830). The controller 120 may determine the speed of change in transmittance based on the speed of the vehicle measured by the speed sensor 150. For example, the controller 120 may increase the speed of change in transmittance of the sunlight shading member 110 in proportion to the speed of the vehicle. The speed of change in transmittance felt by the driver may have a positive correlation with the speed of the vehicle. Based on this fact, the controller 120 may increase the speed of change in transmittance of the sunlight shading member 110 as the speed of the vehicle measured by the speed sensor 150 is faster, and may decrease the speed of change in transmission of the sunlight shading member 110 as the speed of the vehicle measured by the speed sensor 150 is slower.

Next, the controller 120 determines whether the number of times the illuminance changes by a set magnitude or more within a predetermined time has occurred n (n is a natural number) times or more within a predetermined period (S840). For example, the predetermined time may be selected in a range greater than 0 seconds and equal to or less than 10 seconds. In addition, the reference value, number of changes, and predetermined period of the magnitude of change in illuminance may be set differently depending on the vehicle and environment.

Next, when the controller 120 determines that the number of times the illuminance changes by a set magnitude or more within a predetermined time has occurred n (n is a natural number) times or more within a predetermined period, it maintains a constant transmittance of the sunlight shading member 110 (S850). When sunlight is non-continuously radiated onto a vehicle at predetermined time intervals due to objects around the road, topography, etc., the driver may feel rather heterogeneous or uncomfortable if the transmittance of the sunlight shading member 110 changes each time the sunlight is irradiated. In consideration of this point, the controller 120 may maintain a constant transmittance of the sunlight shading member 110 when the number of times the illuminance measured by the illuminance sensor 130 changes by a set magnitude or more within a predetermined time occurs n (n is a natural number) times or more within a predetermined period.

Meanwhile, when the controller 120 determines that the number of times the illuminance changes by a set magnitude or more within a predetermined time has not occurred n (n is a natural number) times or more within a predetermined period, it determines whether it is in automatic mode (S860). Here, the automatic mode refers to a mode in which the controller 120 adjusts the transmittance of the sunlight shading member 110 according to the illuminance based on the calculated amount of felt illuminance and the determined speed of change in transmittance.

Next, when it is determined it is in the automatic mode, the controller 120 adjusts the transmittance of the sunlight shading member 110 in the automatic mode (S870). In other words, the controller 120 adjusts the transmittance of the sunlight shading member 110 based on the previously calculated amount of felt illuminance and the determined speed of change in transmittance. In relation to this, the controller 120 may store in advance the basic settings of the transmittance map by illuminance of the sunlight shading member 110.

In other words, the controller 120 may automatically adjust the transmittance according to the illuminance based on the preset transmittance by illuminance of the sunlight shading member 110, but determine the illuminance by reflecting the amount of felt illuminance, and change the transmittance according to the speed of change in transmittance determined when adjusting the transmittance according to the change in illuminance.

Meanwhile, when it is not determined it is in the automatic mode, the controller 120 adjusts the transmittance of the sunlight shading member 110 in manual mode (S880). The manual mode refers to a mode in which at least one of the transmittance map by illuminance and the speed of change in transmittance is input (selected) by the driver, and the transmittance of the sunlight shading member 110 is adjusted based on information input by the driver. The step of adjusting, by the controller 120, the transmittance of the sunlight shading member 110 in the manual mode may include setting a transmittance map by illuminance according to input information of a driver and determining a speed of change in transmittance.

In addition, the controller 120 may preferentially utilize the setting information input in relation to the speed of change in transmittance in the manual mode, prior to the speed of change in transmittance set based on the speed of the vehicle measured by the speed sensor 150, the rainwater information detected by the rainwater sensor 160, and the like. For example, regardless of the speed of change in transmittance set based on the speed of the vehicle measured by the speed sensor 150, the rainwater information detected by the rainwater sensor 160, and the like, the controller 120 may set a speed of change in transmittance of the sunlight shading member 110 according to setting information input through the speed switch 180.

Meanwhile, the present disclosure also provides a non-transitory computer-readable storage medium having stored thereon a program including at least one instruction for performing the method for controlling a vehicle sunlight shading device according to the various embodiments described above. In this case, the instruction may include not only machine code generated by a compiler but also higher level language code executable by a computer.

The storage medium may include a hardware device configured to store and perform program instructions such as a hard disk, a magnetic medium such as a floppy disk and a magnetic tape, an optical medium such as a compact disk read only memory (CD-ROM) and a digital video disk (DVD), a magneto-optical medium such as a floptical disk, a read-only memory (ROM), a random access memory (RAM), a flash memory, and the like.

Meanwhile, the storage medium may be installed in a vehicle. In more detail, the storage medium may be installed in the ECU of the vehicle.

The vehicle sunlight shading device, the method for controlling the same, and the computer-readable storage medium storing a program for performing the method according to the present disclosure provide an optimal sunlight shading function to a driver by allowing the transmittance of a sunlight shading member installed in a vehicle and having an adjustable transmittance to be adjusted automatically according to the ambient illuminance.

The vehicle sunlight shading device, the method for controlling the same, and the computer-readable storage medium storing a program for performing the method according to an exemplary embodiment of the present disclosure provide an optimal sunlight shading function to a driver by considering any one or more of the inclination of the vehicle, the speed of the vehicle, and whether rainwater is detected, together with the illuminance when adjusting the transmittance of the sunlight shading member.

The vehicle sunlight shading device, the method for controlling the same, and the computer-readable storage medium storing a program for performing the method according to an exemplary embodiment of the present disclosure prevent unnecessary obstruction of visibility by preventing the transmittance adjustment of the sunlight shading member from being performed when a change in illuminance in a certain level or more occurs a set number of times or more within a predetermined period.

The vehicle sunlight shading device, the method for controlling the same, and the computer-readable storage medium storing a program for performing the method according to an exemplary embodiment of the present disclosure improve driver convenience and safety by eliminating the need to adjust the placement angle of a sunlight shading member through a sunlight shading member whose transmittance is automatically adjusted.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

1-20. (canceled)

21. A vehicle sunlight shading device, comprising:
a sunlight shade included in a vehicle, the sunlight shade configured such that transmittance of the sunlight shade is adjustable;
an illuminance sensor configured to measure illuminance around the vehicle; and
a controller configured to control the sunlight shade to adjust the transmittance of the sunlight shade based on the illuminance measured around the vehicle by the illuminance sensor.

22. The vehicle sunlight shading member of claim 21, p1 further comprising a tilt sensor configured to measure a tilt of the vehicle,
wherein the controller is configured to adjust the transmittance of the sunlight shade of the vehicle based on the illuminance measured by the illuminance sensor and the tilt of the vehicle measured by the tilt sensor.

23. The vehicle sunlight shading member of claim 22, wherein the controller is configured to, when the vehicle is on an uphill slope according to the tilt of the vehicle measured by the tilt sensor, control the sunlight shade to lower the transmittance of the sunlight shade than when the vehicle is on a flat surface.

24. The vehicle sunlight shading member of claim 22, wherein the controller is configured to, when the vehicle is on a downhill slope according to the tilt of the vehicle measured by the tilt sensor, control the sunlight shade to increase the transmittance of the sunlight shade than when the vehicle is on a flat surface.

25. The vehicle sunlight shading member of claim 21,
further comprising a speed sensor configured to measure a speed of the vehicle,
wherein the controller is configured to adjust a speed of change in the transmittance of the sunlight shade based on the speed of the vehicle measured by the speed sensor.

26. The vehicle sunlight shading member of claim 25, wherein the controller is configured to increase the speed of the change in the transmittance of the sunlight shade in proportion to the speed of the vehicle measured by the speed sensor.

27. The vehicle sunlight shading member of claim 21,
further comprising a rainwater sensor configured to detect rainwater,
wherein the controller is configured to control the sunlight shade to reduce a speed of change in the transmittance of the sunlight shade when the rainwater is detected by the rainwater sensor.

28. The vehicle sunlight shading member of claim 21, wherein the controller is configured to control the sunlight shade to constantly maintain the transmittance of the sunlight shade when a number of times of changes in the illuminance measured by the illuminance sensor by a set magnitude or more within a predetermined period is greater than or equal to a predetermined number.

29. The vehicle sunlight shading member of claim 21,
further comprising a mode switch for selecting one of a plurality of adjustment modes corresponding to a plurality of correlations between the illuminance around the vehicle and the transmittance of the sunlight shade which are set to be different from each other for adjusting the transmittance of the sunlight shade, respectively,
wherein the controller is configured to store the plurality of adjustment modes, and control the sunlight shade to adjust the transmittance of the sunlight shade according to one of the plurality of the correlations between the illuminance around the vehicle and the transmittance of the sunlight shade corresponding to the selected one of the plurality of adjustment modes selected through the mode switch.

30. A method for controlling a sunlight shade included in a vehicle, the method comprising:
measuring, by an illuminance sensor, illuminance around the vehicle; and
controlling, by a controller, the sunlight shade configured such that transmittance of the sunlight shade is adjustable, wherein the controlling of the sunlight shade comprises controlling the sunlight shade to adjust the transmittance of the sunlight shade based on the illuminance around the vehicle measured by the illuminance sensor.

31. The method claim 30,
further comprising receiving, by the controller, a tilt of the vehicle measured by a tilt sensor,
wherein the controlling of the sunlight shade comprises:
adjusting, by the controller, the transmittance of the sunlight shade based on the illuminance measured by the illuminance sensor and the tilt of the vehicle measured by the tilt sensor.

32. The method of claim 31,
wherein the adjusting of the transmittance of the sunlight shade based on the illuminance measured by the illuminance sensor and the tilt of the vehicle measured by the tilt sensor comprises, when the vehicle is on an uphill slope according to the tilt of the vehicle measured by the tilt sensor, controlling the sunlight shade to lower the transmittance of the sunlight shade than when the vehicle is on a flat surface.

33. The method of claim 31,
wherein the adjusting of the transmittance of the sunlight shade based on the illuminance measured by the illuminance sensor and the tilt of the vehicle measured by the tilt sensor comprises, when the vehicle is on a downhill slope according to the tilt of the vehicle measured by the tilt sensor, controlling the sunlight shade to increase the transmittance of the sunlight shade than when the vehicle is on a flat surface.

34. The method of claim 30,
further comprising receiving, by the controller, a speed of the vehicle measured by a speed sensor,
wherein the controlling of the sunlight shade comprises adjusting, by the controller, a speed of change in the transmittance of the sunlight shade based on the speed of the vehicle measured by the speed sensor.

35. The method of claim 34,
wherein the adjusting of the speed of the change in the transmittance of the sunlight shade comprises increasing the speed of the change in the transmittance of the sunlight shade in proportion to the speed of the vehicle measured by the speed sensor.

36. The method of claim 30,
further comprising receiving, by the controller, rainwater detection information detected by a rainwater sensor,
wherein the controlling of the sunlight shade comprises adjusting, by the controller, a speed of change in the transmittance of the sunlight shade based on the rainwater detection information.

37. The method of claim 36,
wherein the adjusting of the speed of the change in the transmittance of the sunlight shade based on the rainwater detection information comprises reducing the speed of the change in the transmittance of the sunlight shade when the rainwater is detected according to the rainwater detection information.

38. The method of claim 30,
further comprising determining, by the controller, whether a number of times of changes in the illuminance measured by the illuminance sensor by a set magnitude or more within a predetermined period is greater than or equal to a predetermined number.

39. The method of claim 38,
further comprising constantly maintaining the transmittance of the sunlight shade when the number of times of the changes in the illuminance measured by the illuminance sensor by the set magnitude or more within the predetermined period is greater than or equal to the predetermined number.

40. A non-transitory computer-readable medium configured to store instructions, that when executed by a processor, cause the processor to perform operations comprising:
measuring, by an illuminance sensor, illuminance around a vehicle; and
controlling, by a controller, a sunlight shade configured such that transmittance of the sunlight shade is adjustable, wherein the controlling of the sunlight shade comprises controlling the sunlight shade to adjust the transmittance of the sunlight shade based on the illuminance around the vehicle measured by the illuminance sensor.
